(19) United States
(12) Patent Application Publication
(10) Pub. No.: US 2010/0163735 A1
(43) Pub. Date: Jul. 1, 2010

(54) RARE-EARTH MATERIALS, SCINTILLATOR CRYSTALS, AND RUGGEDIZED SCINTILLATOR DEVICES INCORPORATING SUCH CRYSTALS

(75) Inventors: Peter R. Menge, Chagrin Falls, OH (US); Lance J. Wilson, Shaker Height, OH (US)

Correspondence Address: LARSON NEWMAN & ABEL, LLP, 5914 WEST COURTYARD DRIVE, SUITE 200, AUSTIN, TX, 78730, US

(73) Assignee: Saint-Gobain Ceramics & Plastics, Inc., Worcester, MA (US)

(21) Appl. No.: 12/645,274

(22) Filed: Dec. 22, 2009

Related U.S. Application Data
(60) Provisional application No. 61/141,165, filed on Dec. 29, 2008.

(51) Int. Cl. G01T 1/202; B32B 5/00

(52) U.S. Cl. 250/361 R; 428/141

(57) ABSTRACT

A rare-earth halide material comprising a first surface region having a first surface roughness (Rᵣₘₛ₁) and a second surface region having a second surface roughness (Rᵣₘₛ₂), wherein the first surface roughness value is at least about 10% less than the second surface roughness value, wherein surface roughness is measured using scanning white light interferometry over an area of 1 mm².

### CROSS-REFERENCE TO RELATED APPLICATION(S)

The present application claims priority from U.S. Provisional Patent Application No. 61/141,165, filed Dec. 29, 2008, entitled “Rare-Earth Materials, Scintillator Crystals, and Ruggedized Scintillator Devices Incorporating Such Crystals,” naming inventors Peter R. Menge and Lance J. Wilson, which application is incorporated by reference herein in its entirety.

### BACKGROUND

1. Field of the Disclosure

The present disclosure is directed to scintillator crystals and scintillator devices, particularly ruggedized scintillator devices for industrial applications.

2. Description of the Related Art

Scintillation detectors have been employed in various industrial applications, such as the oil and gas industry for well logging. Typically, these detectors have scintillator crystals made of an activated sodium iodide material that is effective for detecting gamma rays. Generally, the scintillator crystals are enclosed in tubes or casings, which include a window permitting radiation induced scintillation light to pass out of the crystal package for measurement by a light-sensing device such as a photomultiplier tube. The photomultiplier tube converts the light photons emitted from the crystal into electrical pulses that are shaped and digitized by associated electronics that may be registered as counts and transmitted to analyzing equipment. In terms of well logging applications, the ability to detect gamma rays makes it possible to analyze rock strata as gamma rays are emitted from naturally occurring radioisotopes, typically of shales that surround hydrocarbon reservoirs. Gamma rays and neutrons may also be scattered off formations by artificial radioactive sources to analyze density and abundance of atomic constituents.

Today, a common practice is to make measurements while drilling (MWD). However, a problem associated with MWD applications is that the detector is used in severe operational environments. The scintillator crystal can be exposed to broad temperature ranges, various atmospheres and gases, shocks, and vibrations that can result in poor detector performance, such as recording false counts and decreases in scintillated light output.

Accordingly, the industry continues to need improvements in scintillator devices, particularly ruggedized scintillator devices that can withstand the harsh environments of industrial applications.

### SUMMARY

According to a first aspect, a rare-earth halide material includes a first surface region having a first surface roughness (Rᵣₘₛ₁) and a second surface region having a second surface roughness (Rᵣₘₛ₂), wherein the first surface roughness value is at least about 10% less than the second surface roughness value, wherein surface roughness is measured using scanning white light interferometry over an area of 1 mm².

According to a second aspect, a scintillator crystal includes a scintillator crystal body made of a rare-earth halide material and having a hexagonal crystal structure, the scintillator crystal body further comprising a surface region having a surface roughness (Rᵣₘₛ₁) within a range between about 1 micron and about 10 microns, wherein surface roughness is measured using scanning white light interferometry over an area of 1 mm².

According to another aspect, a scintillator device includes a housing, a scintillator crystal contained within the housing, wherein the scintillator crystal comprises a surface region having a surface roughness (Rᵣₘₛ) not greater than about 10 microns. The surface roughness is measured using scanning white light interferometry over an area of 1 mm². The device further includes a sleeve surrounding a portion of the scintillator crystal and exerting a radially compressive pressure on the scintillator crystal of at least about 0.5 MPa at room temperature.

In another aspect, a scintillator device includes a housing and a scintillator crystal contained within the housing, wherein the scintillator crystal comprises a hexagonal crystal structure and a surface area:volume (SA:V) ratio of not greater than about 1, and wherein the surface area and volume are measured in centimeters. The device further includes a sleeve surrounding a portion of the scintillator crystal and exerting a first radially compressive pressure on a first region of the scintillator crystal and a second compressive pressure on a second region of the scintillator crystal, wherein the first region and the second region are different regions and the first compressive pressure is different than the second compressive pressure.

According to a fifth aspect, a scintillator device includes a housing and a scintillator crystal contained within the housing, wherein the scintillator crystal comprises a hexagonal crystal structure and a surface area:volume (SA:V) ratio of not greater than about 1, and wherein the surface area and volume are measured in centimeters. The device further includes a sleeve surrounding a portion of the scintillator crystal and exerting a radially compressive pressure on the scintillator crystal, wherein the scintillator crystal withstands a cooling rate of at least about 2° C./min over a temperature range of not greater than about 200° C. to an ambient temperature without cracking.

In still another aspect, a scintillator device includes a housing and a scintillator crystal contained within the housing, wherein the scintillator crystal comprises a hexagonal crystal structure and includes a surface having a surface roughness (Rᵣₘₛ) of not greater than about 10 microns, and wherein surface roughness is measured using scanning white light interferometry over an area of 1 mm². The scintillator crystal is under a radially compressive load of at least 0.5 MPa by a compressive material to limit the maximum endured stress intensity to a value of not greater than about 0.13 Mpa m^{(1/2)} upon heating and cooling the scintillator crystal within a range between an ambient temperature and 200° C. at a cooling rate within a range between about 2° C./min to about 4° C./min.

In another aspect, a scintillator device includes a housing and a scintillator crystal contained within the housing and comprising a material selected from the group of materials consisting of LaBr₃, CeBr₃, LuI₃, LaCl₃, and a combination thereof, wherein the scintillator crystal comprises a surface region having a surface roughness (Rᵣₛₘ) not greater than about 10 microns, wherein surface roughness is measured using scanning white light interferometry over an area of 1 mm². The device further includes a sleeve surrounding a portion of the scintillator crystal and exerting a radially compressive pressure on the scintillator crystal of at least about 0.5 MPa at room temperature.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a radiation detector according to one embodiment.

FIG. 2 includes a cross-sectional illustration of a scintillator device according to one embodiment.

FIG. 3 includes an exploded view of a scintillator device according to one embodiment.

FIG. 4 includes a perspective diagram of a scintillator device according to one embodiment.

FIG. 5 includes an illustration of a scintillator crystal having particular surface regions in accordance with an embodiment.

FIG. 6 includes an illustration of a scintillator crystal having particular surface regions in accordance with an embodiment.

FIG. 7 includes an illustration of a scintillator crystal and a sleeve in accordance with an embodiment.

FIG. 8 includes a cross-sectional illustration of a portion of a scintillator crystal and a portion of a sleeve in accordance with an embodiment.

FIG. 9 includes a cross-sectional illustration of a portion of a sleeve in accordance with an embodiment.

FIG. 10 includes a cross-sectional illustration of a portion of a sleeve and a shock absorbing member in accordance with an embodiment.

The use of the same reference symbols in different drawings indicates similar or identical items.

### DETAILED DESCRIPTION

According to a one aspect, a radiation detector device is disclosed that includes a scintillator housing coupled to a photosensor. The scintillator housing includes a scintillator crystal, a shock absorbing member substantially surrounding the scintillator crystal, and a casing substantially surrounding the shock absorbing member and having a window in one end. The scintillator crystal is a material that is sensitive to particular types of radiation, for example, gamma rays, such that when it is struck by radiation the scintillator responds by fluorescing or scintillating electromagnetic radiation at a known wavelength. The fluoresced radiation can be captured and recorded by a photosensor, such as a photomultiplier tube, which converts the fluoresced radiation to an electrical signal for processing. As such, the detector provides users with an ability to detect and record radiation events, which in the context of MWD applications, may enable users to determine the composition rock strata surrounding a borehole.

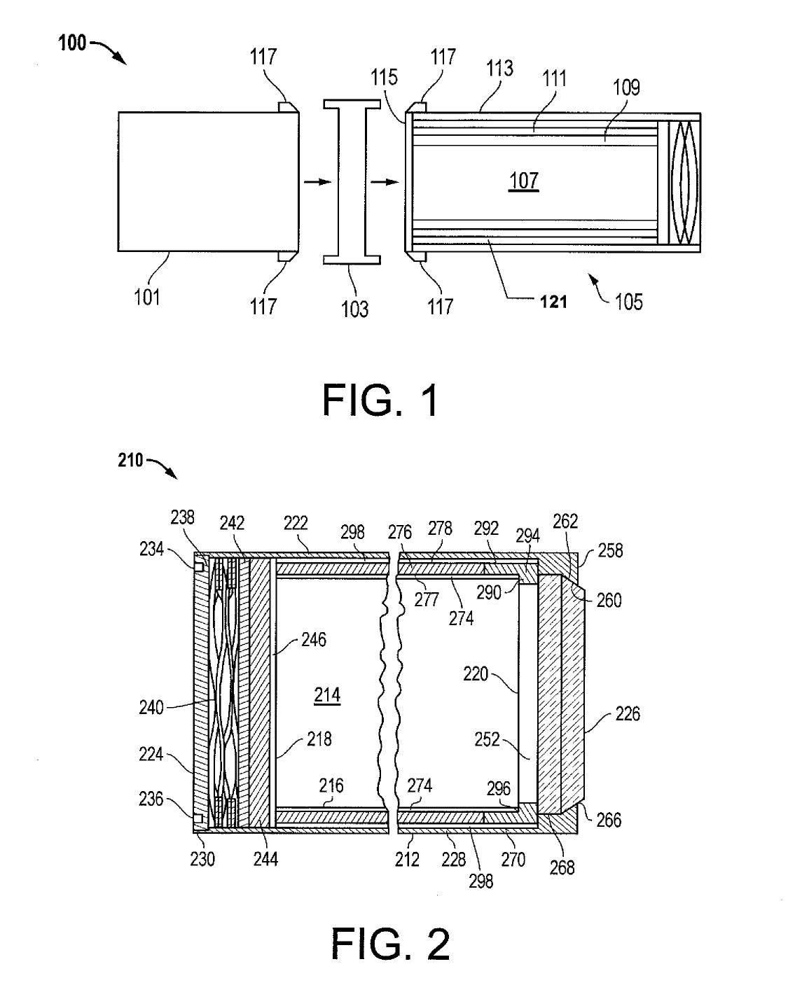

FIG. 1 illustrates a radiation detector according to one embodiment. As illustrated, the radiation detector 100 includes a photosensor 101, light pipe 103, and a scintillator housing 105. As mentioned above, the scintillator housing 105 can include a scintillator crystal 107 disposed within and substantially surrounded by a reflector 109. The scintillator crystal 107 and reflector 109 can further be surrounded by a shock absorbing member 111, which in turn can also be surrounded by a sleeve 121. The scintillator crystal 107, reflector 109, shock absorbing member 111, and sleeve 121 can be housed within a casing 113 which includes a window 115 at one end of the casing 113.

In further reference to FIG. 1, the photosensor 101 can be a device capable of spectral detection and resolution, such as a photomultiplier tube or other detection device. The photons emitted by the scintillator crystal 107 are transmitted through the window 115 of the scintillator housing 105, through the light pipe 103, to the photosensor 101. As is understood in the art, the photosensor 101 provides a count of the photons detected, which provides data on the radiation detected by the scintillator crystal. The photosensor 101 can be housed within a tube or housing made of a material capable of withstanding and protecting the electronics of the photosensor 101, such as a metal, metal alloy or the like. Various materials can be provided with the photosensor 101, such as within the detection device housing, to stabilize the detection device during use and ensure good optical coupling between the light pipe 103 and the scintillator housing 105.

As illustrated, the light pipe 103 is disposed between the photosensor 101 and the scintillator housing 105. The light pipe 103 can facilitate optical coupling between the photosensor 101 and the scintillator housing 105. According to one embodiment, the light pipe 103 can be coupled to the scintillator housing 105 and the photosensor 101 using biasing members 117 that provide a spring resiliency. Such biasing members 117 can facilitate absorption of shocks to the detector 100 which can reduce false readings and counts during use of the device. As will be appreciated, the biasing members can be used in conjunction with other known coupling methods such as the use of an optical gel or bonding agent.

The scintillator housing 105 can be a sealed vessel having an atmosphere that is sealed from and different than the ambient atmosphere. The atmosphere of the housing can be a non-oxidizing atmosphere, such as an inert atmosphere including an inert gas, for example a noble gas, nitrogen or a combination thereof. In particular instances, the atmosphere within the scintillator housing can comprise not greater than about 50 ppm oxygen or even not greater than about 25 ppm. Moreover, certain scintillator crystals 107 may be hygroscopic materials, and accordingly the amount of water vapor within the atmosphere is controlled such that the water content within the scintillator housing 105 is not greater than about 20 ppm.

In further reference to the scintillator device, FIG. 2 provides an illustration of a scintillator device 210 according to one embodiment. The scintillator device 210 includes a scintillator crystal 214 disposed within a housing 212. The scintillator crystal 214 can have various shapes, for example, a rectangular or cylindrical shape 216 as illustrated including flat end faces 218 and 220.

In further reference to FIG. 2, the housing 212 can include a casing 222 that can be cylindrical or tubular to effectively fit the shape of the scintillator crystal 214. The casing 222 can be closed at its rear end by a back cap 224 and at its front end by an optical window 226. The optical window 226 can include a material that is transmissive to scintillation radiation emitted by the scintillator crystal 214. According to one embodiment, the optical window 226 is made of sapphire. The casing 222 and back cap 224 can be made of a non-transmissive material, such as a metal, metal alloy, or the like. As such, in one embodiment, the casing 222 and the back cap 224 are made of stainless steel, aluminum, or titanium. The back cap 224 can be coupled to the casing 222 using a sealant, mechanical fasteners, or by a vacuum type peripheral weld. According to a particular embodiment, the casing 222 can have a recess in the casing wall to form a welding flange 230, which facilitates fitting the back cap 224. Additionally, the back cap 224 can include an opening to its outer side such that annular grooves 234 and 236 are spaced slightly inwardly from the circumferential edge. Welding is performed at the outer ends of the welding flange 230 and the reduced thickness of a connecting portion 238 of welding flange 230 reduces welding heat, conducting heat away from the welding flanges to permit formation of a desired weld.

The scintillator device 210 further includes a biasing member 240, a backing plate 242, a cushion pad 244, and an end reflector 246. The biasing member 240, can include a spring, as illustrated, or other suitable resilient biasing members. The biasing member 240 functions to axially load the crystal 214 and bias it towards the optical window 226. According to one embodiment, the biasing member 240 can be a stack of wave springs disposed crest-to-crest as shown. Other suitable biasing members can include but are not limited to, coil springs, resilient pads, pneumatic devices or even devices incorporating a semi-compressible liquid or gel. As such, suitable materials for the biasing member 240 can include a metal, a metal alloy, polymers, or the like.

The backing plate 242 disperses the force of the biasing member 240 across the area of the cushion pad 244 for substantially uniform application of pressure and axial loading of the rear face 218 of the scintillator crystal 214. Alternatively, the backing plate and biasing member may be integrated into a single structure, such as in the case of an elastomeric polymer member, which may have a rigid reinforcement layer. The cushion pad 244 can be made of a resilient material such as a polymer, particularly an elastomer, such as, a silicone rubber. The thickness of the cushion pad 244 can vary within a range of 0.07 to 0.75 cm for crystals ranging in diameter from 0.6 to 7.6 cm and in length from 1.3 to 38 cm.

Additionally, the cushion pad 244 can be adjacent to the end reflector 246. The end reflector 246 can include a suitable reflecting material such as a powder, like aluminum oxide (alumina) powder, or a reflective tape or foil such as, a white porous unsintered PTFE material. A porous reflective material facilitates the escape of air or gas from between the reflector film and crystal face and can avoid pockets of trapped air or gas which could prevent the end reflector 246 from being pushed by the cushion pad 244 flat against the rear end face 218 of the scintillator crystal 214 which can have a negative impact on reflectivity at the reflector-crystal interface. The reflector material may be 0.010 inches thick. According to particular embodiment, the reflecting material is a film that can be wrapped at least once around the crystal and possibly two or more times as desired. Alternatively, the end reflector 246 can be a metal foil disk, which conforms to the surface of the crystal end face 218 and provides suitable reflectance toward the optical window 226.

In accordance with a particular embodiment, the end reflector 246 is a preformed sheet containing a fluorinated polymer. In one embodiment, the fluorinated polymer can include a fluorine substituted olefin polymer comprising at least one monomer selected from the group consisting of vinylidene fluoride, vinylfluoride, tetrafluoroethylene, hexafluoropropylene, trifluoroethylene, chlorotrifluoroethylele, ethylene-chlorotrifluoroethylene, and mixtures of such fluoropolymers. In one particular embodiment, the end reflector 246 is made essentially of a fluorinated polymer. In another more particular embodiment, the end reflector 246 is made essentially of polytetrafluoroethylene (PTFE).

As indicated above, the biasing member 240 exerts a force on the scintillator crystal 214, to urge the scintillator crystal 214 towards the optical window 226 thereby maintaining suitable optical coupling between the scintillation crystal 214 and the optical window 226. An optional layer 252 (or interface pad) can be provided between the scintillator crystal 214 and the optical window 226 to facilitate effective optical coupling. According to one embodiment, layer 252 can include a transparent polymer material, such as a transparent silicone elastomer. The thickness of the interface pad 252 can be within a range of 0.07 to 0.75 cm for crystals ranging in diameter from 0.6 to 7.6 cm and in length from 1.3 to 38 cm.

In further reference to FIG. 2, as illustrated, the optical window 226 can be retained in the casing 222 by an annular lip 258 at the front end of the casing 222. The annular lip 258 can protrude radially inwardly from the casing wall 228 and can define an opening having a diameter less than the diameter of the optical window 226. Additionally, the annular lip 258 can have an inner beveled surface 260 and the optical window 226 can include a corresponding beveled, circumferential edge surface 262 that engages the inner beveled surface 260. The mating beveled surfaces can be hermetically sealed by a high temperature solder such as 95/5 or 90/10 lead/tin solder. The solder also aids in restraining the optical window 226 against axial push-out, in addition to providing a high temperature seal. The optical window 226 can be axially trapped between the annular lip 258 and the scintillator crystal 214 such that it can be radially constrained by the casing wall 222. Optionally, to permit wetting of the optical window 226 by the solder, the sealing edge surfaces of the optical window 226 can include a metalized coating such as platinum.

According to the illustrated embodiment of FIG. 2, the inner beveled surface 260 can forwardly terminate at a cylindrical surface 266 and rearwardly at a cylindrical surface 268. The cylindrical surface 268 closely surrounds a portion of the optical window 226 and extends axially inwardly to a cylindrical surface 270, which extends axially to the flange 230 at the opposite end of the casing 222. The interface of the optical window 226 is aligned with the annular shoulder formed between the cylindrical surfaces 268 and 270.

According to another embodiment, the scintillator crystal 214 can be substantially surrounded by a reflector 274. The reflector 274 can incorporate materials as described above in accordance with the end reflector 246, such as a porous material including a powder, foil, metal coating, or polymer coating. According to one embodiment, the reflector 274 is a layer of aluminum oxide (alumina) powder. In another embodiment, the reflector 274 is a self-adhering white porous PTFE material. As noted above, air or gas that might otherwise be trapped between the end reflector 246 and the scintillator crystal 214 can escape through the porous reflector 274.

In one embodiment, the reflector 274 can be substantially surrounded by a liner (not illustrated) disposed between the outer surface of the reflector 274 and the inner surface 277 of a shock absorbing member 276. Such a liner can include a metal material, particularly a thin metal liner such as a foil. In accordance with a particular embodiment, the coating material can include aluminum foil.

In accordance with a particular embodiment, the reflector 274 is a preformed sheet containing a fluorinated polymer. In one embodiment, the fluorinated polymer can include a fluorine substituted olefin polymer comprising at least one monomer selected from the group consisting of vinylidene fluoride, vinylfluoride, tetrafluoroethylene, hexafluoropropylene, trifluoroethylene, chlorotrifluoroethylele, ethylene-chlorotrifluoroethylene, and mixtures of such fluoropolymers. In one particular embodiment, the reflector 274 is made essentially of a fluorinated polymer. In another more particular embodiment, the reflector 274 is made essentially of polytetrafluoroethylene (PTFE).

In addition to the reflector 274 surrounding the scintillator crystal 214, a shock absorbing member 276, can substantially surround the scintillator crystal 214. The shock absorbing member 276 can surround and exert a radial force on the reflector 274 and the scintillator crystal 214. As shown, the shock absorbing member 276 can be cylindrical to accompany the selected shape of the scintillator crystal 214. The shock absorbing member 276 can be made of a resiliently compressible material and according to one embodiment, is a polymer, such as an elastomer. Additionally, the surface contour of the shock absorbing member 276 can vary along the length to provide a frictionally engaging surface thereby enhancing the stabilization of the scintillator crystal 214 within the casing 222. For example, the shock absorbing member 276 can have a uniform inner surface 277 and an outer surface 278, or optionally, can have ribs extending axially or circumferentially on the inner surface 277, the outer surface 278, or both. Still, the shock absorbing member 276 can have protrusions, dimples, or other shaped irregularities on the inner surface 277, the outer surface 278, or both surfaces to frictionally engage the scintillator crystal 214 and the casing 222. The shock absorbing member is discussed in more detail below.

As also illustrated, the scintillator device 210 can include a ring 290 that extends from the front end of the shock absorbing member 276 to the optical window 226. The ring 290 facilitates stabilization and alignment of the circular interface pad 252 during assembly of the scintillator device 210. The ring 290 has an axially inner end portion 292 substantially surrounding the scintillator crystal 214 and an axially outer end portion 294 substantially surrounding the interface pad 252. The intersection of the interior surfaces of the axially inner end portion 292 and the axially outer end portion 294 can include a shoulder 296, which facilitates positioning of the ring 290 on the scintillator crystal 214 during assembly.

In certain embodiments, the ring 290 can be made of resilient material, including an organic material, such as an elastomer. In one particular embodiment, the ring 290 is in direct contact with the inner surface of the casing 222 and the outer surface of the scintillator crystal 214, but may not necessarily provide a hermetically sealing interface between the scintillator crystal 214 and the shock absorbing member 276, such as relying on an interference fit between the crystal 214 and the and the shock absorbing member 276.

Moreover, the ring 290 can include additional materials, generally located within the inner surface and abutting the scintillator crystal 214 to enhance the reflection of the ring 290. Such materials can include, for example, alumina or PTFE (Teflon™). The ring 290 and the shock absorbing member may alternatively be integrated together as a continuous integral component.

In further reference to the components of the scintillator device 210 as illustrated in FIG. 2, a sleeve 298 extends longitudinally from the optical window 226 to approximately the back cap 224. The sleeve 298 can substantially surround the shock absorbing member 276 and scintillator crystal 214 and in a compressed state (when fitted within the casing 222) provides a radially compressive force to the shock absorbing member 276 and scintillator crystal 214. According to one embodiment, insertion of the sleeve 298 into the casing 222 requires compression of the sleeve thereby providing a radially compressive force on the crystal 214. Suitable materials for the sleeve 298 include resilient materials, such as a metal, metal alloy, a polymer, carbon or the like. Additionally, the sleeve 298 can include a material that has a different coefficient of friction with the material of the casing 222 than the material of the shock absorbing member 276 with the material of the casing 222.

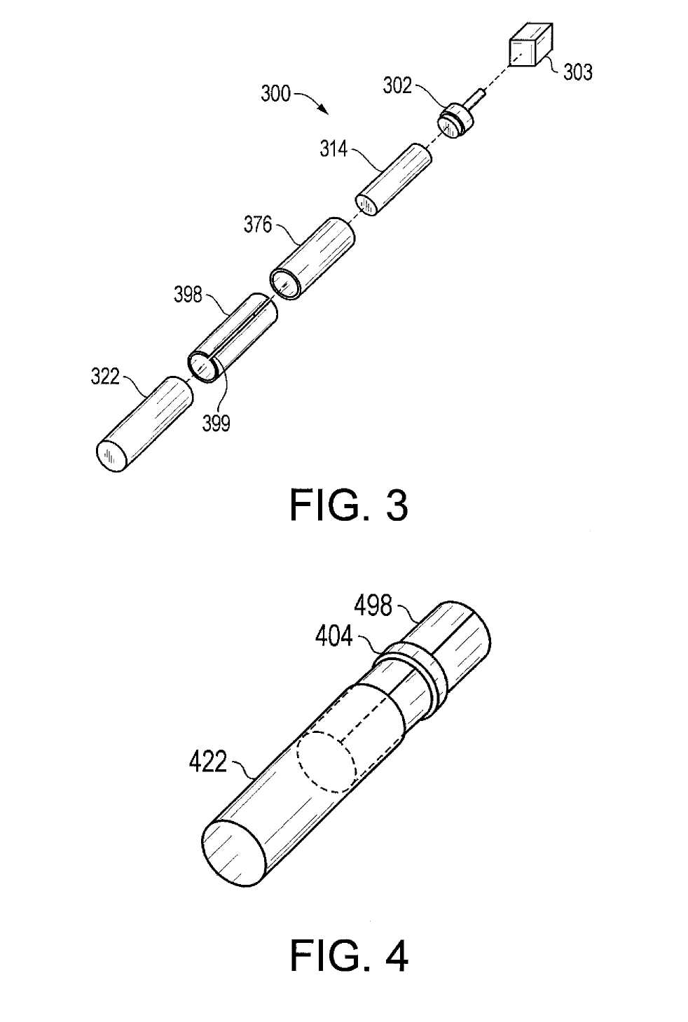

In further reference to the sleeve 298 and its incorporation into the scintillator device 210, FIG. 3 provides an exploded view of the arrangement 300 of the component layers of the scintillator device according to one embodiment. As illustrated in FIG. 3, the sleeve 398 can be slotted along its longitudinal length, thereby providing a longitudinally extending gap 399. The width of the longitudinally extending gap 399 when the shock absorbing member 376 is disposed within the sleeve 398 without any externally applied compression can vary, and can generally be wide. However, when a radially compressive force is applied and the sleeve 398 and shock absorbing member 376 are inserted into the casing 322 the width of the longitudinally extending gap 399, can be zero or near zero. The sleeve 398 can be compressible in other suitable ways, for example, the sleeve 398 may be fluted or crimped to allow for radial compression of the sleeve 398 along its axial length.

FIG. 3 further provides a particular assembly of the scintillator device 300 according to one embodiment. After applying a reflector to the scintillator crystal 314, the subassembly of the reflector and scintillator crystal 314 can be inserted into the shock absorbing member 376 and this subassembly can be inserted in the sleeve 398 to form a scintillator crystal 314-shock absorbing member 376-sleeve 398 subassembly. Before insertion of this subassembly into the casing 322, the sleeve 398 can be in an uncompressed state, and the diameter of the sleeve 398 can be greater than the inside diameter of the metal casing 322. A radial compressive force can be applied to the scintillator crystal 314-shock absorbing member 376-sleeve 398 subassembly during insertion into the casing 322. To facilitate insertion, a forcing mechanism 302 can be used. The forcing mechanism 302, can apply an axial force to the scintillator crystal 314-shock absorbing member 376-sleeve 398 subassembly, and can include devices such as a hydraulic ram or push rod 302 coupled to a conventional control apparatus 303.

Referring to FIG. 4, the incremental compression of the scintillator crystal 314-shock absorbing member 376-sleeve 398 subassembly (illustrated in FIG. 3 and denoted as 498 in FIG. 4) during insertion into the casing 422 can be facilitated by use of a clamp 404. The clamp 404 can include various devices capable of exerting a radially compressive force, such as a radial clamp or compression ring. The clamp 404 can be adjusted to change positions along the longitudinal length of the scintillator crystal 314-shock absorbing member 376-sleeve 398 subassembly 498 during insertion of the subassembly into the casing 422. It will be appreciated that the size of the clamp 404 will depend upon the size of the subassembly 498 and the rigidity of the sleeve 398 and the desired compressive force suitable for effective insertion of the subassembly 498 into the casing 422. Additionally, the axial rigidity of the sleeve 398 can impact the location at which the radial clamp 404 is applied to the sleeve 398. Accordingly, the subassembly 498 may be progressively inserted at increments.

In further reference to the coupling of the components of the subassembly 498 within the casing 422, the sleeve 398/casing 422 interface may have a reduced coefficient of friction relative to the coefficient of friction of a typical casing 422/shock absorbing member 376 interface which would exist without the sleeve 398. As such, the reduced coefficient of friction facilitated by incorporation of a sleeve 398 to form a sleeve 398/casing 422 interface facilitates assembly of the device and reduces the potential for damage to the components of the scintillator crystal 314-shock absorbing member 376-sleeve 398 subassembly. Moreover, provision of the sleeve 398/casing 422 interface may provide a suitable radial loading for stabilization of the device during operation.

The foregoing description has provided illustrations and explanations of particular components within embodiments of a detector for protection of a scintillator crystal during use in industrial applications. The following is directed to further details and features of certain components for forming ruggedized assemblies suitable for particular scintillator materials.

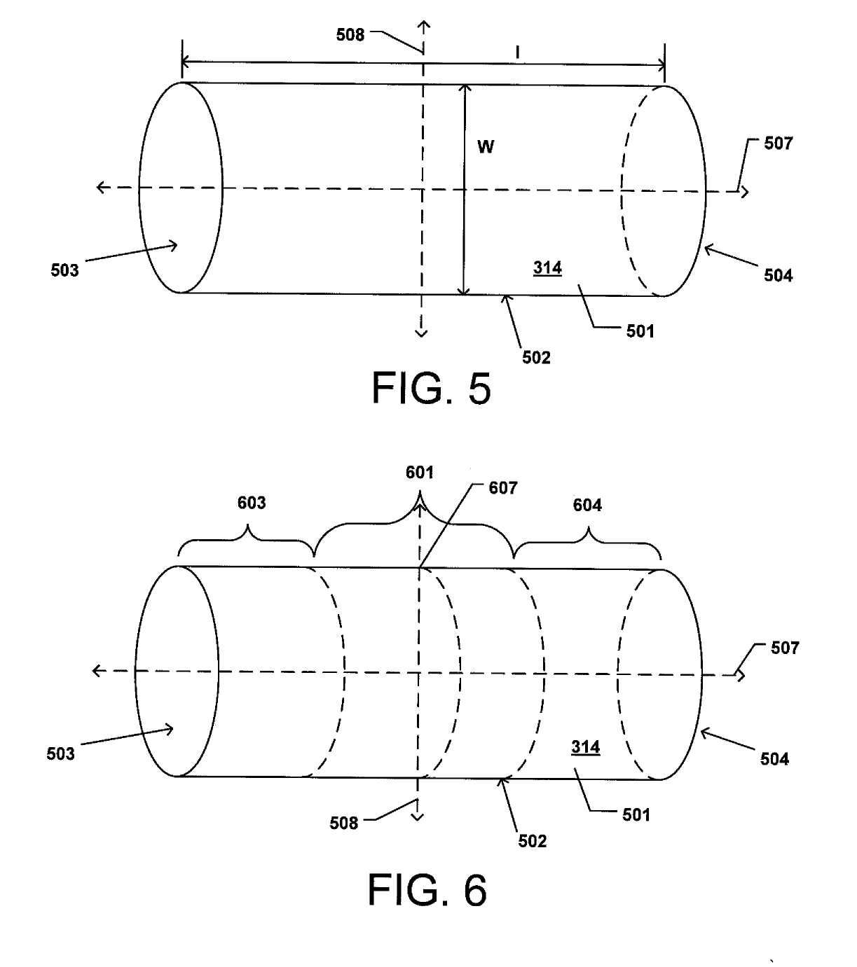

FIG. 5 includes an illustration of a scintillator crystal in accordance with an embodiment. Notably, the scintillator crystals herein can provide improved light output intensity, however, certain materials may be particularly sensitive to environmental conditions (temperature, atmosphere, etc.) and may also be susceptible to mechanical failure. For example, the scintillator crystal 314 can be a hygroscopic material. According to one embodiment, the scintillator crystal 314 includes a rare-earth halide material. Rare-earth materials include elements having atomic numbers ranging from 57 to 71, and further including the elements Y and Sc. Notably, the rare-earth halide material can be a monocrystalline material, and particularly a scintillator material capable of fluorescing at particular wavelengths in response to certain types of radiation, such as gamma rays.

The rare-earth materials can be combined with halide elements from Group VII of the Periodic Table of Elements. However, in particular instances, certain halide materials such as bromine, chlorine, or iodine are combined with the rare-earth elements. Certain embodiments utilize rare-earth halide materials such as LaBr₃, CeBr₃, LuI₃, LaCl₃, and a combination thereof. According to one particular embodiment, the scintillator crystal 314 consists essentially of LaBr₃. It will be appreciated that these materials can include dopants that provide suitable scintillation characteristics.

Additionally, the scintillator crystal 314 can have a particular crystalline structure. For example, the scintillator crystal body 501 can have a hexagonal crystal structure. Moreover, the scintillator crystal body 501 can have a particular cleavage plane that is based on the atomic crystal structure and results in preferential cleaving along one plane as opposed to the other planes within the crystal structure. Accordingly, cleavage planes can present a plane that preferentially cleaves under a lower stress than other planes, otherwise a mechanically weaker portion of the crystal structure than non-cleavage planes. For some embodiments, the scintillator crystal 314 includes a material having a cleavage plane.

The scintillator crystal 314 can also have certain mechanical properties such that particular ruggedization techniques described herein are utilized. For example, the scintillator crystal 314 may be a particularly brittle material. As such, the scintillator crystal 314 can have a Vickers hardness that is about 200 MPa. In other instances, the Vickers hardness may be greater, such as at least about 300 MPa, at least about 400 MPa or even at least about 500 MPa. Certain scintillator crystals 314 have a Vickers hardness within a range between about 200 MPa and 500 MPa. Additionally, certain brittle scintillator crystal materials can have a low elastic modulus, such as not greater than about 30 MPa. According to one embodiment, the scintillator crystal 314 has an elastic modulus that is not greater than about 25 MPa, such as not greater than about 20 MPa, and on the order of about 15 MPa, or even about 10 MPa. In accordance with a particular embodiment, the scintillator crystal 314 has an elastic modulus within a range between about 10 MPa and about 20 MPa. Moreover, the scintillator crystal materials can be dense materials, such as at least about 95% dense (wherein 100% dense corresponds to the theoretical density). In fact, in some embodiments, the scintillator crystal material is at least about 97%, such as at least 98%, or even 99% dense.

Certain scintillator crystal materials can be brittle materials. For example, the scintillator crystal 314 can have a fracture toughness, Kc, that is not greater than about 0.4 MPa m^{(1/2)}. In other instances, the fracture toughness is less, such that it is not greater than about 0.3 MPa m^{(1/2)}, not greater than about 0.14 MPa m^{(1/2)}, such as on the order of about 0.12 MPa m^{(1/2)}, 0.11 MPa m^{(1/2)}, 0.1 MPa m^{(1/2)}, or even about 0.08 MPa m^{(1/2)}. The fracture toughness of the scintillator crystal 314 is generally within a range between about 0.1 MPa m^{(1/2)} and about 0.4 MPa m^{(1/2)}, and more particularly between about 0.1 MPa m^{(1/2)} and about 0.14 MPa m^{(1/2)}.

As further illustrated in FIG. 5, the scintillator crystal 314 can have a body 501 of a particular shape. The scintillator crystal body 501 can be an elongated member having a length (l), or height (h) in the particular context of a cylindrical shape, extending along a direction of a longitudinal axis 507 between a first end 503 and a second end 504. Moreover, the scintillator crystal body 501 can have a width (w), or diameter (d) in the particular context of a cylindrical shape, extending along a lateral axis 508 that bisects the length (l) of the scintillator crystal body 501 and intersects a peripheral side surface 502 of the body 501 extending between the first end 503 and the second end 504.

As illustrated in FIG. 5, the scintillator crystal body 501 can have a cylindrical body, and particularly can have a height greater than or equal to the diameter. Generally, the diameter is at least about 5 cm. In other instances, the diameter may be greater, such that it is at least about 6 cm, at least about 7 cm, and particularly within a range between about 5 cm and 10 cm.

Accordingly, the scintillator crystal body 501 can have a particular aspect ratio, which is a ratio of the width to the length (i.e., w:l). For example, the scintillator crystal body 501 can have an aspect ratio of at least about 0.75, such as at least about 0.8, and on the order of about 0.85, about 0.9, about 0.95, or even 1. In one embodiment, the scintillator crystal body 501 has an aspect ratio within a range between about 0.75 and about 1, and more particularly within a range between about 0.85 to about 1.

Moreover, the scintillator crystal body 501 can have a shape such that the surface area of the body 501 is at least about 180 cm². Some bodies 501 can have a greater surface area, for example, at least about 200 cm², at least about 225 cm², at least about 250 cm², or even at least about 275 cm². Certain scintillator crystal bodies 501 utilize a surface area within a range between about 175 cm² and about 500 cm².

The scintillator crystal body 501 can have a significant volume to improve the probability of detecting and interacting with radiation. Accordingly, scintillator crystal bodies herein have volumes of at least about 200 cm³. However, the volume may be larger for certain bodies, such as the on the order of at least about 225 cm³, 250 cm³, 275 cm³ or even at least about 300 cm³. Particular scintillator crystal bodies have a volume within a range of about 200 cm³ and about 500 cm³.

Notably, the large volume of the scintillator crystal bodies used herein can result in large thermal gradients within the body during rapid heating and cooling. Such thermal gradients can expose the scintillator crystal body 501 to high stresses, which may result in fracture. Such thermal gradients are particularly relevant when the scintillator crystal body 501 has a particular surface area to volume (SA:V) ratio of not greater than about 1, wherein the surface area and volume are measured in centimeters. Notably, the scintillator crystal bodies herein can have a SA:V ratio of not greater than about 1, such as not greater than about 0.95, not greater than about 0.9, or even on the order of about 0.85, about 0.8, or about 0.75. Particular embodiments utilize scintillator crystal bodies 501 having a SA:V ratio within a range between about 0.5 to about 1, and more particularly, within a range between about 0.7 to about 0.9.

In accordance with a particular embodiment, a surface region of the scintillator crystal body 501 can have a particular surface roughness (Rᵣₘₛ). The surface roughness is a root-mean-squared (rms) surface roughness measured using scanning white light interferometry over an area of 1 mm². The surface roughness measurements can be made such that at least 10 different and separate 1 mm² regions are tested across the particular surface region of the crystal body 501 for accurate sampling. Notably, the scintillator crystal body 501 can have a surface region having a particular surface roughness (Rᵣₘₛ₁) such that maximum surface features (e.g. protrusions or crevices) within the surface are minimized, thereby reducing regions of stress concentrations along the surface. Such surface roughness values can be particularly suitable for brittle scintillator crystal materials. Accordingly, the surface region of the scintillator crystal body 501 can have a surface roughness (Rᵣₘₛ₁) of not greater than about 10 microns. In particular embodiments, the surface region has a surface roughness (Rᵣₘₛ₁) within a range between about 1 micron and about 10 microns, and more particularly within a range between about 2 microns and about 8 microns. For certain embodiments, the scintillator crystal body 501 can have a surface region having a surface roughness (Rᵣₘₛ₁) within a range between about 3 microns and about 7 microns.

As illustrated, the scintillator crystal body 501 includes a peripheral side surface 502 extending between and connecting the first end 503 and the second end 504. According to one embodiment, the surface region having the particular surface roughness values (Rᵣₘₛ₁) described in the foregoing can be along the peripheral side surface 502. In particular, placement of the surface region along the peripheral side surface 502 is suitable for reducing stress concentration regions along the length (l) of the scintillator crystal body 501, especially when a cleavage plane is aligned perpendicular to the peripheral side surface 502. In accordance with one particular embodiment, the surface region having the particular surface roughness may extend over the entire external surface area of the peripheral side surface 502. Moreover, in certain instances the surfaces of the ends 503 and 504 may also include such a surface region having the particular surface roughness values (Rᵣₘₛ₁) described above.

In some embodiments, the scintillator crystal body can have another surface region (i.e., a second surface region) having a surface roughness value (Rᵣₘₛ₂) that is different than the surface roughness value (Rᵣₘₛ₁) of the surface region noted above (i.e., first surface region). In fact, certain degrees of surface roughness have proven suitable for improving the detected light output intensity of scintillator crystals. Accordingly, the scintillator crystal body 501 may include second surface regions having a surface roughness that is greater than the roughness of the first surface region. That is, the second surface region can be referred to herein as a “rough region” in comparison to the first surface region, otherwise referred to herein as a “smooth region”. As such, in certain embodiments, the smooth region can have a surface roughness value (Rᵣₘₛ₁) of at least about 10% less than the rough region. In certain embodiments, the difference in surface roughness is greater, such that the smooth region can have a surface roughness value (Rᵣₘₛ₁) of at least about 30%, such as at least 40%, at least 50%, or even at least 75% less than the surface roughness value (Rᵣₛₘ₂) of the rough region. Particular embodiments utilize a smooth region having a surface roughness value (Rᵣₘₛ₁) that is within a range between about 25% and 90% less than the surface roughness value (Rᵣₘₛ₂) of the rough region.

In further reference to the differences of surface roughness between the smooth region and the rough region, generally the difference in surface roughness (ΔRᵣₘₛ) is at least about 5 microns. In other instances, the difference can be greater, such that it is at least about 8 microns, at least about 10 microns, at least about 12 microns, 15 microns or even 20 microns. Certain embodiments utilize a difference in surface roughness (ΔRᵣₘₛ) between the smooth region and rough region within a range between about 5 microns and 20 microns.

Generally, the rough region can have a surface roughness value (Rᵣₘₛ₂) that is greater than about 11 microns. For example, the surface roughness value (Rᵣₘₛ₂) of the rough region can be at least about 12 microns, at least about 14 microns, such as on the order of about 16 microns, about 18 microns, or about 20 microns. According to one particular embodiment, the rough region has a surface roughness (Rᵣₘₛ₂) a range between about 11 microns and about 20 microns.

More particularly, the rough region can have a particular peak-to-valley roughness (Rt) that is a measure of the maximum roughness value between a greatest peak and a lowest valley as measured using the same techniques for measuring the R. In certain embodiments, the Rt surface roughness can be at least about 10 microns, such as at least about 12 microns, at least about 15 microns, at least about 16 microns, at least about 18 microns, at least about 20 microns, or even at least about 22 microns. In particular instances, the Rt surface roughness of the rough region can be within a range between about 10 microns and about 40 microns, such as within a range between about 12 microns and about 35 microns, within a range between about 15 microns and about 30 microns, or even within a range between about 16 microns and about 28 microns.

It will also be appreciated, that the scintillator crystal body 501 can exhibit the same differences in the peak-to-valley surface roughness (Rt) between the smooth region and the rough region as described with regards to the surface roughness (Rᵣₘₛ). That is, the smooth region and rough region can have comparable differences (e.g., percentage difference or actual value differences) in the value of Rt that are the same as the described Rᵣₘₛ values.

The rough region can be at particular locations on the scintillator crystal body 501. As described herein, in certain embodiments, the first end 503 or second end 504 of the scintillator crystal 314 can abut the pad 252 adjacent to the window 226, such that fluoresced radiation from the scintillator crystal 314 travels through the window 226 and is detected by photosensor 101. As such, at least a portion of the first end 503 or second end 504 can have a surface roughness value (Rᵣₘₛ₂) corresponding to that of a rough region to facilitate suitable light extraction characteristics. For example, according to one embodiment, at least 50% of the external surface area of the first end 503 or the second end 504 can have a surface roughness value (Rᵣₘₛ₂) corresponding to a rough region. In particular embodiments, the entire external surface area of the first end 503 or second end 504 can be a rough region. In still other embodiments, both the first end 503 and second end 504 can have a surface roughness values (Rᵣₘₛ₂) corresponding to a rough region. In fact, other external surfaces of the scintillator crystal body 501 can have surface roughness values (Rᵣₘₛ₂) corresponding to that of a rough region.

Referring to FIG. 6, an illustration of a scintillator crystal is provided in accordance with an embodiment. As illustrated, the scintillator crystal 314 has a body 501 similar to that as illustrated in FIG. 5. However, the scintillator crystal body 501 includes a peripheral side surface 502 having a first region 601 disposed between a second region 603 and a third region 604, wherein the second region 603 and third region 604 are abutting the first and second ends 503 and 504, respectively. As will be appreciated, each of the regions can extend axially along the length of the scintillator crystal body, and further extend circumferentially around the exterior surface of the peripheral side surface 501.

In accordance with an embodiment, one of the first region 601, second region 603, and third region 604 can be formed such that at least one of the regions has a surface roughness that is different than a surface roughness within the other regions. For example, the first region 601 may have a surface roughness that is different than the surface roughness of the second region 603 and third region 604. In particular, the first region 601 can be a smooth region, while the second region 603 and third region 604 can have a surface roughness corresponding to that of a rough region. Moreover, as described herein, a portion of or even all of the first end 503 and/or the second end 503 and 504 can be a rough region.

Notably, embodiments herein can include a scintillator crystal body 501 wherein the midpoint 607 of the peripheral side surface 502, which is a region extending circumferentially along the exterior surface of the peripheral side surface and intersected by the lateral axis 508, has a lower surface roughness than other surfaces of the scintillator crystal body 501. Utilization of a first region 601, and in particularly a region encompassing the midpoint 607, having a smooth region surface roughness value (Rᵣₘₛ₁) can reduce the likelihood of fracture of the crystal within this region.

The first region 601 encompasses the midpoint 607 of the scintillator crystal body 501, and can be centered at the midpoint 607. Generally, the first region 601 can extend over a certain percentage of the external surface area of the peripheral side surface 502. For instance, the first region 601 may extend for at least about 10% of the external surface area of the peripheral side surface 502. In other instances, the first region may cover a greater area, such as at least about 20%, at least about 30%, or even at least about 40% of the external surface area of the peripheral side surface 502. Particular embodiments may utilize a first region 601 covering at least about 10% and not greater than about 75% of the total external surface area of the peripheral side surface 502.

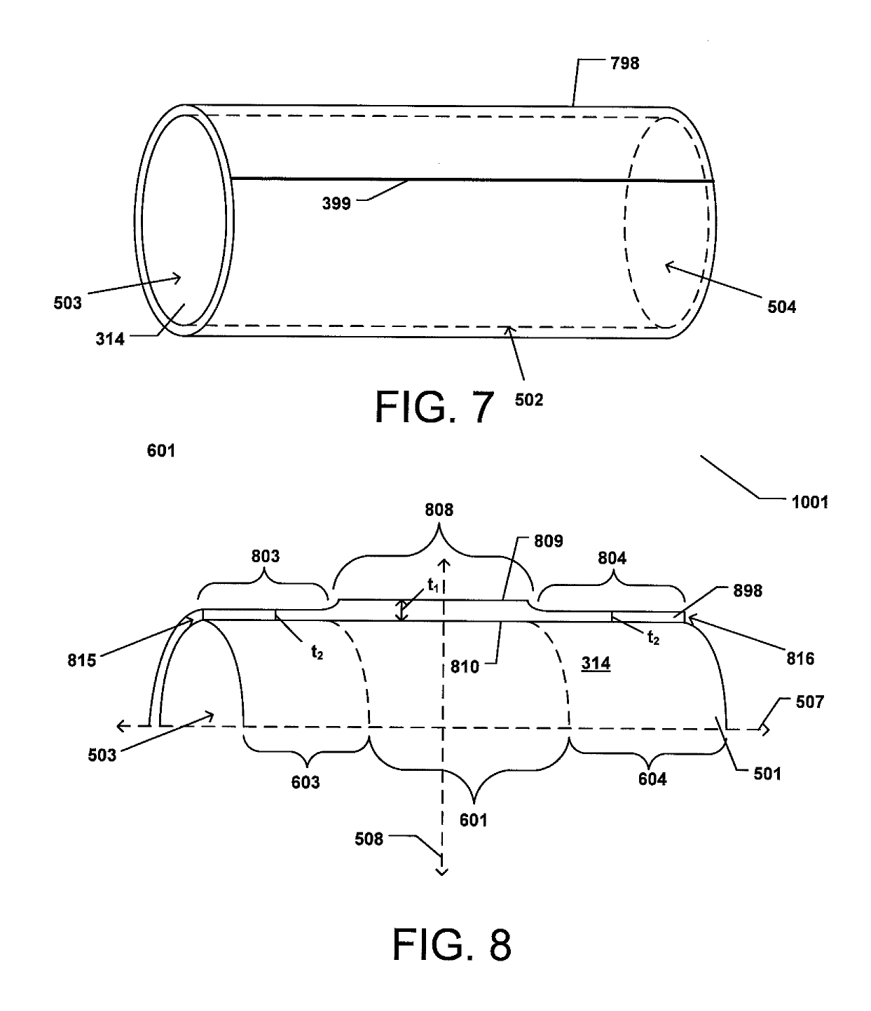

FIG. 7 includes an illustration of a scintillator crystal and a sleeve in accordance with an embodiment. As illustrated in FIG. 7, the scintillator crystal 314 is disposed within the sleeve 798 such that the sleeve 798 substantially surrounds the scintillator crystal 314 along the peripheral side surface 502 of the scintillator crystal 314. It will be appreciated that other components, such as the reflector and shock absorbing member, which are not illustrated, may be disposed within the sleeve 798 between the scintillator crystal 314 and the sleeve 798. In accordance with particular embodiments, the sleeve 798 may have certain features that facilitate ruggedization of certain scintillator crystal materials. For example, the sleeve 798 can be formed and disposed around the scintillator crystal such that it exerts a radially compressive pressure on the scintillator crystal to reduce tensile stresses within the scintillator crystal body. According to one embodiment, the sleeve 798 can exert a radially compressive pressure of at least about 0.5 MPa at room temperature. In other instances, the compressive pressure exerted by the sleeve 798 can be greater, such as at least about 0.6 MPa, at least about 0.8 MPa or even at least about 1 MPa at room temperature. Certain embodiments herein utilize a sleeve 798 exerting a radially compressive pressure within a range between about 0.5 MPa and about 2 MPa, such as between about 0.5 MPa and about 1.5 MPa, or even between about 0.5 MPa and about 1 MPa at room temperature. Such pressures generally exceed those used in conventional designs, and are intended to exert pressures in excess of approximately 2.0 MPa at temperatures above 175° C. It will be appreciated, that given the arrangements of components described herein, a shock absorbing member can be disposed within the sleeve and configured to directly deliver the load to the crystal, as illustrated in FIG. 10.

FIG. 8 includes a cross-sectional illustration of a portion of a scintillator crystal and a portion of a sleeve in accordance with an embodiment. In particular, the sleeve 898 includes a first region 808 disposed between second region 803 and a third region 804, wherein the second region 803 and third region 804 are abutting the ends 815 and 816 of the sleeve 898. As illustrated and according to a particular embodiment, the sleeve 898 can have different thicknesses corresponding to different regions, such that the sleeve 898 is capable of providing different radial compressive pressures to the scintillator crystal body along the axial length. As illustrated, the sleeve 898 can have a first thickness (t₁) within the first region 808 that is greater than a second thickness (t₂) within the second and third regions 803 and 804. As such, the first region 808 of the sleeve 898 is capable of providing a greater radial compressive pressure to the scintillator crystal body 501 within region 601 than within the second and third regions 803 and 804. Notably, the sleeve 898 can provide a suitable radially compressive pressure at the midpoint 607 of the scintillator crystal body 501, which can correspond to the region 601 of the scintillator crystal body 501 that can be a smooth region as described herein.

In particular instances, the sleeve 898 is formed such that the first region 808 provides a compressive pressure that is at least about 10% greater than a compressive pressure provided by the sleeve 898 in the second and third regions 803 and 804. In fact, the first region 808 may provide a greater differential pressure, such as at least about 20%, at least about 30%, at least about 40%, or even about 50% greater than a compressive pressure exerted within the second and third regions 803 and 804.

In terms of particular values, the first region 808 of the sleeve 898 may exert a compressive pressure on the scintillator crystal body 501 that is at least about 0.2 MPa greater than a compressive pressure exerted on the body within the second and third regions 803 and 804. In other instances, the compressive pressure provided to the scintillator crystal body 501 within the first region 808 is at least about 0.3 MPa greater, such as at least about 0.4 MPa, at least about 0.5 MPa, or even at least about 0.75 MPa greater than the compressive pressure exerted within the second and third regions 803 and 804. In particular embodiments, the first region 808 exerts a compressive pressure within a range between about 0.2 MPa and about 1 MPa greater than the compressive pressure exerted by the sleeve 898 within the second and third regions 803 and 804.

The inner surface 810 of the sleeve 898 is particularly uniform along the axial length defined by the longitudinal axis 507. By contrast, the outer surface 809 of the sleeve 898, particularly within the first region 808, includes a protrusion facilitating the difference in thickness between the first region 808 and the second and third region 803 and 804. However, other designs may be utilized to facilitate a difference in thickness or difference in the radially compressive pressure exerted on the scintillator crystal 501 along its length, such as placement of ribs or other features along the inner surface 810 or outer surface 809 of the sleeve 898.

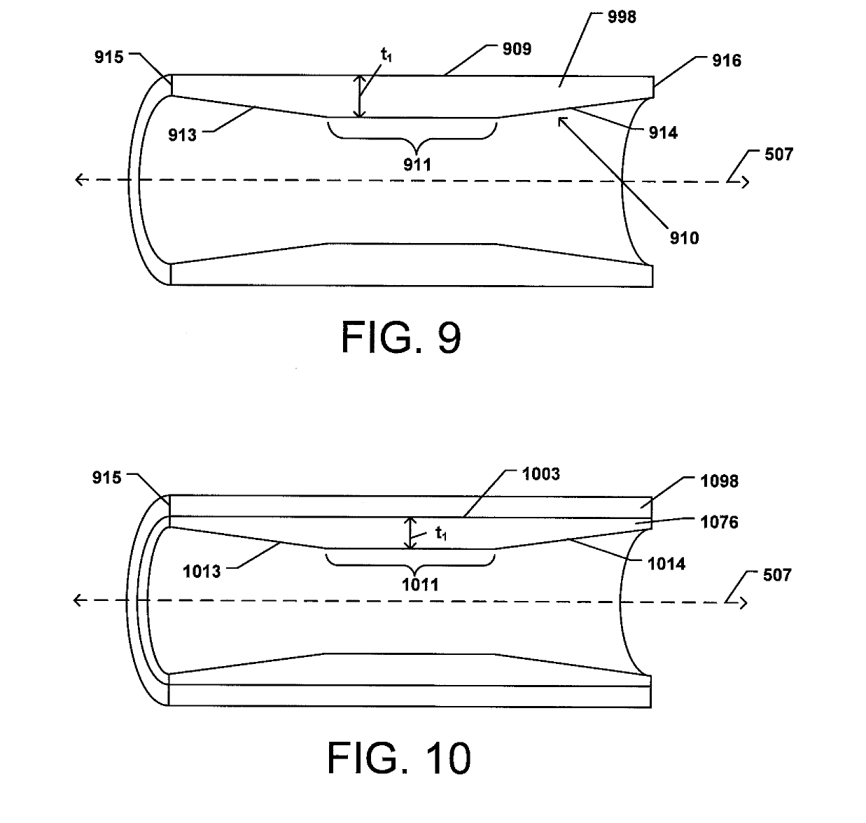

For example, FIG. 9 illustrates a cross-sectional view of a sleeve in accordance with an embodiment. Notably, the sleeve 998 includes an outer surface 909 which is substantially flat and extends parallel to the longitudinal axis 507. In contrast, the inner surface 910 of the sleeve 998 includes surface features, such as a region 911 disposed between two tapered surfaces 913 and 914. Notably, the thickness (t₁) of the sleeve 998 within the region 911 is greater than the thickness of the sleeve 998 within the tapered regions. Such a design facilitates a sleeve 998 capable of providing differential radial compressive pressures along the axial length of the scintillator crystal body. In particular, the sleeve 998 can provide a greater radial compressive pressure to the scintillator crystal body within region 911 and provide gradually less compressive pressure along the tapered surfaces 913 and 914 as the thickness of the sleeve 998 decreases from the central region 911 to the ends 915 and 916. Such a design may be suitable for particular scintillator crystal materials prone to fracture proximate to a midpoint.

Moreover, while reference has been made herein to a sleeve having particular shapes and surface features for providing different radially compressive pressures along a longitudinal length, in certain embodiments, the sleeve can be combined with the shock-absorbing member. FIG. 10 includes a cross-sectional illustration of a portion of a sleeve and shock-absorbing member in accordance with an embodiment. As illustrated, a sleeve 1098 is coupled to a shock absorbing member 1076 along an inner surface 1003 of the sleeve 1098. In particular, the sleeve 1098 can be slideably coupled to the shock absorbing member 1076, or alternatively, fixably attached to the shock absorbing member 1076, such as through use of an adhesive or the like. Moreover, as illustrated, the sleeve 1098 can have a generally constant thickness along the length in the direction of the longitudinal axis 507, however, the shock absorbing member 1076 has a differential thickness along its length. In fact, the shock absorbing member 1076 has a profile similar to that of the sleeve 998 of FIG. 9, including a region 1011 having a thickness (t₁) that is disposed between two tapered surfaces 1013 and 1014. The combination of the sleeve 1098 and shock absorbing member 1076 having such a design may be suitable for particular scintillator crystal materials prone to fracture proximate to a midpoint.

The shock absorbing member 1076 can be made of a material suitable for maintaining a compressive pressure on the scintillator crystal 314, particularly when the scintillator 314 is exposed to a broad range of temperatures. For example, the shock absorbing member 1076 can include a polymer material, such as silicone, and particularly a porous polymer material. Suitable porous polymer materials can have porosities in excess of about 40 vol % of the total volume of the shock absorbing member 1076. For example, the porous material can have a porosity of at least about 50 vol %, such as at least 60 vol % or even at least 75 vol %. In certain circumstances, the shock absorbing member 1076 may include a foam material such that it includes a high degree of porosity. The porosity may be open porosity that forms an interconnected network of channels extending throughout the sleeve body such that in certain circumstances the porosity may exceed 70 vol % such as on the order of at least about 80 vol % or even at least about 90 vol %.

For example, in certain embodiments, the shock absorbing member 1076 can be made of a material generally having a high CTE thus capable of exerting a greater radially compressive pressure on the scintillator crystal body with increasing temperature. For example, the shock absorbing member 1076 can have a CTE of at least about 280E-6 m/m/° C. In other embodiments, a material having a greater CTE can be used, such as on the order of at least about 300E-6 m/m/° C., at least about 320E-6 m/m/° C., at least about 350E-6, or even 375E-6 m/m/° C. Particular embodiments utilize a shock absorbing member 1076 having a CTE within a range between about 280E-6 m/m/° C. and about 400E-6 m/m/° C.

While the embodiments herein have made reference to particular components such as a sleeve capable of providing a radially compressive pressure to the scintillator crystal, other compressive materials may be provided within the housing, in addition to the sleeve or in exclusion of the sleeve, to provide a suitable compressive pressure to the scintillator crystal. For example, in one embodiment, the housing can include a pressurized gas capable of providing a suitable compressive pressure to the scintillator crystal. In still another embodiment, the housing can include a fluid capable of proving a suitable compressive pressure to the scintillator crystal. In such instances utilizing a fluid, the scintillator crystal may be contained within a fluid tight sealed container such that contamination does not chemically alter the scintillator crystal or its light output capabilities.

In accordance with embodiments herein, devices are disclosed that can include a scintillator crystal, shock absorbing member, sleeve, and other components such that the device, and particularly the scintillator crystal, can withstand particular thermal gradients. For example, the scintillator crystal may be able to withstand tensile stresses based upon cooling rates of at least about 2° C./min over a temperature range of not greater than about 200° C. to an ambient temperature without cracking In certain other instances, the cooling rate that the scintillator crystal can withstand may be greater, such as at least about 2.5° C./min, such as at least about 2.6° C./min, at least about 2.7° C./min, 2.8° C./min or even 3° C./min over a temperature range from 200° C. to ambient temperature without cracking Still, assemblies herein facilitate use of a scintillator crystal capable of withstanding cooling rates from about 2° C./min to about 4° C./min over a temperature range of 200° C. to an ambient temperature without cracking In certain embodiments, the maximum temperature may be slightly less than 200° C., such as about 190° C., about 180° C., or even about 175° C. Still, the temperature range is from at least about an ambient temperature to about 170° C.

Likewise, the scintillator crystal can be packaged such that it can withstand heating rates likely to cause thermal gradients and thus stress within the crystal body. For example, the scintillator crystal may be able to withstand stresses based upon heating rates of at least about 2° C./min over temperatures ranging from an ambient temperature to temperatures not greater than about 200° C. without cracking In certain other instances, the heating rates that the scintillator crystal can withstand may be greater, such as at least about 2.5° C./min, such as at least about 2.6° C./min, at least about 2.7° C./min, 2.8° C./min or even 3° C./min over a temperature range from an ambient temperature to about 200° C.

The devices herein can also facilitate control of the maximum endured stress intensity encountered by the scintillator crystal body. Generally, the devices herein can be designed such that the maximum endured stress intensity of the scintillator crystal is not greater than about 0.13 MPa m^{(1/2)}. In other embodiments, the maximum endured stress intensity may be less, such as not greater than about 0.12 MPa m^{(1/2)}, not greater than about 0.11 MPa m^{(1/2)}, or even not greater than about 0.1 MPa m^{(1/2)}. Still, the maximum endured stress intensity can be within a range of about 0.08 MPa m^{(1/2)} and about 0.13 MPa m^{(1/2)}, while in other instances, the range may be shifted slightly, such as between about 0.06 MPa m^{(1/2)} and about 0.1 MPa m^{(1/2)}.

### EXAMPLES

The following provides a comparative example between two devices including a scintillator crystal exposed to particular heating and cooling conditions to determine the efficacy of certain components. A first sample (Sample A) was prepared and included a LaBr₃ scintillator crystal having a diameter of 6.6 cm and a length of 7.6 cm. The crystal surfaces were roughened using 80 grit alumina powder such that all surfaces had a surface roughness (Rᵣₘₛ) of approximately 16 microns and a Rt of approximately 65 microns as measured by a NT1100 Optical Profilometry System, available from Veeco® over approximately 1 mm² area for 10 different square areas along the roughened surface region. The crystal was cleaned and subject to heating from an initial ambient temperature of 20° C. at a heating rate of 2° C./min to a temperature of 175° C., held at 175° C. for 24 hours, and cooled at a cooling rate of 2° C./min to 20° C. Cracking was observed in the crystal during cooling at approximately 163° C. After the heating process, the crystal was sectioned to observe the nature of the cracks and it was observed that the vast majority of cracks were initiated proximate to the midpoint of the crystal body and extended into the interior of the crystal.

A second sample (Sample B) was prepared using a LaBr₃ scintillator crystal having a diameter of 6.6 cm and a length of 7.6 cm. The crystal surfaces were roughened using 240 grit alumina powder such that all surfaces had a surface roughness (Rᵣₘₛ) of approximately 3.2 microns and a Rt of approximately 27 microns as measured by a NT1100 Optical Profilometry System, available from Veeco® over a 1 mm² area over 10 distinct square areas along the roughened surface region. The crystal was cleaned and placed in a sleeve, wherein the sleeve exerted a pressure of approximately 0.6 MPa at room temperature and a pressure of approximately 2.0 MPa at 175° C. The crystal was subject to heating from an initial ambient temperature of 20° C. at a heating rate of 2.5° C./min to a temperature of 175° C., held at 175° C. for 24 hours, and cooled at a cooling rate of 2.5° C./min to 20° C. No cracking was observed in the crystal during heating or cooling, thus indicating the assembly sufficiently reduced internal stresses within the scintillator crystal due to thermal gradients that would otherwise cause cracks.

The embodiments herein represent a departure from the state-of-the-art. Notably, the embodiments herein utilize scintillator crystals having a combination of particular materials directed to controlling stresses induced within the scintillator crystal based on thermal gradients. Previous scintillator crystals have been packaged in ruggedized assemblies to protect them from shocks and vibrations, which were believed to be the primary source of mechanical damage to the crystals. However, upon conducting empirical studies driven by the need of industrial applications for larger crystals capable of withstanding harsher environments, it was discovered that thermal gradients, particularly those experienced during rapid cooling, can cause significant tensile stresses within the crystal body. Particularly, these stresses are most apt to be located around the midpoint of the crystal since this region can be susceptible to the largest thermal gradients. Such stresses were discovered to be sufficient to cause fracturing of certain crystals. As such, the assemblies of the embodiments herein include a combination of features, including surface roughness values, smooth regions and rough regions, sleeve designs, sleeve materials, and other components for controlling the stress within the crystalline material during use in harsh environments not previously encountered.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

1. A rare-earth halide material comprising a first surface region having a first surface roughness (Rᵣₘₛ₁) and a second surface region having a second surface roughness (Rᵣₘₛ₂), wherein the first surface roughness value is at least about 10% less than the second surface roughness value, wherein surface roughness is measured using scanning white light interferometry over an area of 1 mm².

2. The rare-earth halide material of claim 1, wherein the first surface roughness value is at least about 25% less than the second surface roughness value.

3. The rare-earth halide material of claim 2, wherein the first surface roughness value is at least about 50% less than the second surface roughness value.

4. (canceled)

5. The rare-earth halide material of claim 1, wherein the first surface region and the second surface region have a surface roughness difference (ΔRᵣₘₛ) of at least about 5 microns.

6. The rare-earth halide material of claim 5, wherein the ΔRᵣₘₛ is at least about 8 microns.

7. (canceled)

8. The rare-earth halide material of claim 1, wherein the first surface roughness (Rᵣₘₛ₁) is not greater than about 10 microns.

9. (canceled)

10. (canceled)

11. The rare-earth halide material of claim 1, wherein the second surface roughness is (Rᵣₘₛ₂) is greater than about 11 microns.

12. (canceled)

13. The rare-earth halide material of claim 1, wherein the rare-earth halide material comprises an elongated body having a longitudinal axis extending along a length and intersecting a first end and second end, the elongated body further including a lateral axis bisecting the length of the elongated body and intersecting a peripheral side surface extending between the first and second ends.

14. The rare-earth halide material of claim 13, wherein a portion of one of the first end and second end comprise the second surface region.

15. (canceled)

16. (canceled)

17. The rare-earth halide material of claim 13, wherein the peripheral side surface comprises the first surface region.

18. The rare-earth halide material of claim 17, wherein at least about 10% of the peripheral side surface comprises the first surface region.

19. (canceled)

20. (canceled)

21. The rare-earth halide material of claim 13, wherein the elongated body is a cylindrical body having a height extending along the longitudinal axis between the first end and second end, and a diameter extending along the lateral axis, wherein the height≧diameter.

22. The rare-earth halide material of claim 21, wherein the first surface region is located at a midpoint between the first and second ends and intersected by the lateral axis, and wherein the first surface region extends around the circumference of the cylindrical body.

23. The rare-earth halide material of claim 1, wherein the material comprises a monocrystalline material.

24. The rare-earth halide material of claim 23, wherein monocrystalline material comprises a hexagonal crystal structure.

25. (canceled)

26. (canceled)

27. (canceled)

28. (canceled)

29. The rare-earth halide material of claim 1, wherein the material comprises a fracture toughness, Kc, of not greater than about 0.4 Mpa m^{(1/2)}.

30. (canceled)

31. (canceled)

32. A scintillator crystal comprising:
a scintillator crystal body comprising a rare-earth halide material and having a hexagonal crystal structure, the scintillator crystal body further comprising a surface region having a surface roughness (Rᵣₘₛ₁) within a range between about 1 micron and about 10 microns, wherein surface roughness is measured using scanning white light interferometry over an area of 1 mm².

33. The scintillator crystal of claim 32, wherein the scintillator crystal body is an elongated body having a longitudinal axis extending along a length and intersecting a first end and second end, the scintillator crystal body further including a lateral axis bisecting the length of the scintillator crystal body and intersecting a peripheral side surface extending between the first and second ends.

34. (canceled)

35. (canceled)

36. The scintillator crystal of claim 32, wherein the scintillator crystal body comprises a surface area:volume (SA:V) ratio of not greater than about 1, wherein the surface area and volume are measured in centimeters.

37. The scintillator crystal of claim 36, wherein the SA:V ratio is not greater than about 0.95.

38-81. (canceled)

82. A scintillator device comprising:
a housing;
a scintillator crystal contained within the housing, wherein the scintillator crystal comprises a hexagonal crystal structure and a surface area:volume (SA:V) ratio of not greater than about 1, wherein the surface area and volume are measured in centimeters; and
a sleeve surrounding a portion of the scintillator crystal and exerting a radially compressive pressure on the scintillator crystal, wherein the scintillator crystal withstands a cooling rate of at least about 2° C./min over a temperature range of not greater than about 200° C. to an ambient temperature without cracking

83. The device of claim 82, wherein the scintillator crystal withstands a cooling rate of at least about 2.5° C./min over a temperature range of not greater than about 200° C. to an ambient temperature without cracking.

84. The device of claim 83, wherein the scintillator crystal withstands a cooling rate of at least about 3° C./min over a temperature range of not greater than about 200° C. to an ambient temperature without cracking.

85. The device of claim 84, wherein the scintillator crystal withstands a cooling rate within a range between about 2° C./min to about 4° C./min over a temperature range of not greater than about 200° C. to an ambient temperature without cracking.

86. The device of claim 84, wherein the scintillator crystal withstands a cooling rate of at least about 3° C./min over a temperature range of not greater than about 175° C. to an ambient temperature without cracking.

87-100. (canceled)
